(19) United States
(12) Patent Application Publication
(10) Pub. No.: US 2026/0131612 A1
(43) Pub. Date: May 14, 2026

(54) RIDE HEIGHT ADJUSTMENT ON NON-LEVEL SURFACES

(71) Applicant: Rivian IP Holdings, LLC, Irvine, CA (US)

(72) Inventor: Thomas Frederick ABDALLAH, Warren, MI (US)

(21) Appl. No.: 19/384,284

(22) Filed: Nov. 10, 2025

Related U.S. Application Data
(60) Provisional application No. 63/718,505, filed on Nov. 8, 2024.

(51) Int. Cl. B60G 17/015; B60G 17/0165

(52) U.S. Cl. CPC B60G 17/0155; B60G 17/0165; B60G 2202/152; B60G 2400/252; B60G 2400/51222; B60G 2400/60; B60G 2400/821; B60G 2401/28; B60G 2500/2041; B60G 2500/2042; B60G 2500/2044; B60G 2800/914

(57) ABSTRACT

A vehicle controller of a vehicle is configured to receive an instruction to adjust a ride height of a vehicle. If a surface supporting the vehicle does not meet a requirement for flatness and levelness, adjust an amount of air in an air spring of each suspension of a plurality of suspensions of the vehicle to achieve a target air mass for each suspension. If the surface supporting the vehicle meets the requirement for flatness and levelness, the vehicle controller is configured to adjust the amount of air in the air spring of each suspension of the plurality of suspensions of the vehicle to achieve a target output from a ride height sensor of each suspension.

### RELATED APPLICATION

This application claims the benefit of U.S. Provisional Application Serial No. 63/718,505 filed November 8, 2024, and entitled RIDE HEIGHT ADJUSTMENT ON NON-LEVEL SURFACES, which is hereby incorporated herein by reference in its entirety.

### FIELD OF THE INVENTION

The present disclosure relates to adjusting the ride height of a vehicle.

### SUMMARY

In one aspect, a vehicle controller is configured to receive an instruction to adjust a ride height of a vehicle. The vehicle controller is configured to, if a surface supporting the vehicle does not meet a requirement for flatness and levelness, adjust an amount of air in an air spring of each suspension of a plurality of suspensions of the vehicle to achieve a target air mass for each suspension.

In some embodiments, the vehicle controller is further configured to, if the surface supporting the vehicle meets the requirement for flatness and levelness, adjust the amount of air in the air spring of each suspension of the plurality of suspensions of the vehicle to achieve a target output from a ride height sensor of each suspension.

In some embodiments, the vehicle controller is further configured to adjust the ride height to achieve the target air mass in the air spring of each suspension of the plurality of suspensions by, for each suspension of the plurality of suspensions: receiving a ride height measurement from a ride height sensor of each suspension; receiving a pressure measurement of pressure in the air spring of each suspension; calculating an estimated air mass according to the ride height measurement and the pressure measurement; and adjusting the amount of air in the air spring according to the estimated air mass and the target air mass for each suspension.

In some embodiments, the vehicle controller is further configured to, for each suspension of the plurality of suspensions: calculate a volume of the air spring of each suspension according to the ride height measurement; and calculate the estimated air mass according to pVⁿ, where p is the pressure measurement, V is the volume, and n is polytropic constant of air.

In some embodiments, the vehicle controller is further configured to: estimate a loading of each suspension of the plurality of suspensions; receive a ride height measurement from a ride height sensor of each suspension; receive a pressure measurement of pressure in the air spring of each suspension; and calculate the target air mass for each suspension according to the loading, the ride height measurement, and the pressure measurement.

In some embodiments, the requirement for flatness and levelness includes an angle of less than 5 degrees. In some embodiments, the requirement for flatness and levelness includes height differences among the plurality of suspensions of less than 5 centimeters.

In another aspect, a vehicle includes a plurality of suspensions each including an air spring. The vehicle includes a vehicle controller coupled to the air spring of each suspension of the plurality of suspensions. The vehicle controller is configured to receive an instruction to adjust a ride height of the vehicle. If a surface supporting the vehicle does not meet a requirement for flatness and levelness, the vehicle controller is configured to adjust an amount of air in the air spring of each suspension of the plurality of suspensions of the vehicle to achieve a target air mass for each suspension.

In some embodiments, the vehicle controller is further configured to, if the surface supporting the vehicle meets the requirement for flatness and levelness, adjust the amount of air in the air spring of each suspension of the plurality of suspensions of the vehicle to achieve a target output from a ride height sensor of each suspension.

In some embodiments, the vehicle further includes one or more pressure sensors configured to sense pressure in the air spring of each suspension of the plurality of suspensions. Each suspension of the plurality of suspensions may include a ride height sensor. The vehicle controller is further configured to adjust the ride height to achieve the target air mass in the air spring of each suspension of the plurality of suspensions by, for each suspension of the plurality of suspensions: receiving a ride height measurement from the ride height sensor of each suspension; receiving a pressure measurement of the pressure in the air spring of each suspension from the one or more pressure sensors; calculating an estimated air mass according to the ride height measurement and the pressure measurement; and adjusting the amount of air in the air spring according to a difference between the estimated air mass and the target air mass for each suspension.

In some embodiments, the vehicle further includes an air source, a plenum, a first valve controlling air flow from the air source into the plenum, a second valve controlling air flow from the plenum to an environment of the vehicle, and a plurality of third valves each controlling air flow to and from the air spring of one suspension of the plurality of suspensions. The vehicle further includes a vehicle controller configured to add air to the air spring of each suspension of the plurality of suspensions by opening the first valve and a third valve of the plurality of third valves controlling the air flow to and from the air spring of each suspension of the plurality of suspensions.

In some embodiments, the vehicle controller is further configured to remove air from the air spring of each suspension of the plurality of suspensions by the third valve of the plurality of third valves controlling the air flow to and from the air spring of each suspension of the plurality of suspensions.

In some embodiments, the one or more pressure sensors include a pressure sensor configured to sense pressure within the plenum, the vehicle controller being further configured to measure the pressure in the air spring of each suspension of the plurality of suspensions by: opening the second valve and the third valve of the plurality of third valves controlling the air flow to and from the air spring of each suspension of the plurality of suspensions; and receiving an output of the pressure sensor.

In some embodiments, the vehicle controller is further configured to, for each suspension of the plurality of suspensions: calculate a volume of the air spring of each suspension according to the ride height measurement; and calculate the estimated air mass according to pVn, where p is the pressure measurement, V is the volume, and n is polytropic constant of air.

In some embodiments, the vehicle further includes one or more pressure sensors configured to sense pressure in the air spring of each suspension of the plurality of suspensions. Each suspension of the plurality of suspensions includes a ride height sensor. The vehicle controller may be further configured to: estimate a loading of each suspension of the plurality of suspensions; receive a ride height measurement from the ride height sensor of each suspension; receive a pressure measurement of the pressure in the air spring of each suspension from the one or more pressure sensors; and calculate the target air mass for each suspension according to the loading, the ride height measurement, and the pressure measurement.

In some embodiments, the requirement for flatness and levelness includes an angle less than 5 degrees. In some embodiments, the vehicle further includes an inertial measurement unit (IMU), the vehicle configured to sense the angle via the IMU. In some embodiments, the requirement for flatness and levelness includes height differences among the plurality of suspensions of less than 5 centimeters.

In another aspect, a non-transitory computer-readable medium storing executable code that, when executed by a vehicle controller, cause the vehicle controller to receive an instruction to adjust a ride height of a vehicle. If a surface supporting the vehicle does not meet a requirement for flatness and levelness, an amount of air in an air spring of each suspension of a plurality of suspensions of the vehicle is adjusted to achieve a target air mass for each suspension.

In some embodiments, if the surface supporting the vehicle meets the requirement for flatness and levelness, the amount of air in the air spring of each suspension of the plurality of suspensions of the vehicle is adjusted to achieve a target output from a ride height sensor of each suspension.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of a vehicle controller in accordance with certain embodiments.

FIG. 2B is a schematic block diagram of alternative embodiment of a vehicle controller in accordance with certain embodiments.

FIG. 3 illustrates components that are used to control ride height of a vehicle in accordance with certain embodiments.

FIG. 4 illustrates a method for selecting between different feedback mechanisms when adjusting ride height in accordance with certain embodiments.

FIG. 5 illustrates a method for performing feedback control based on estimated air mass in accordance with certain embodiments.

### DETAILED DESCRIPTION

It is advantageous to have a vehicle with adjustable ride heights. A low ride height may be used to facilitate entry in the vehicle or when traveling at high speeds on smooth surfaces. A high ride height may be useful when driving over rough terrain. When the suspension of the vehicle includes air springs and the vehicle is not on a level and flat surface, adjusting the ride height based on the measured ride height of the vehicle may result in adding an amount of air to the air springs that achieves a target ride height while on the surface. However, when the vehicle begins driving on a level and flat surface, the air springs may compress or expand due to a change in loading, causing the vehicle body to be at an angle relative to the road. For this reason, prior vehicles prevented ride height adjustment on non-flat and non-level surfaces. Using the approach described herein, an adjustment in ride height is accomplished by targeting an air mass within each air spring such that the vehicle body does not become crooked when transitioning to a flat and level surface.

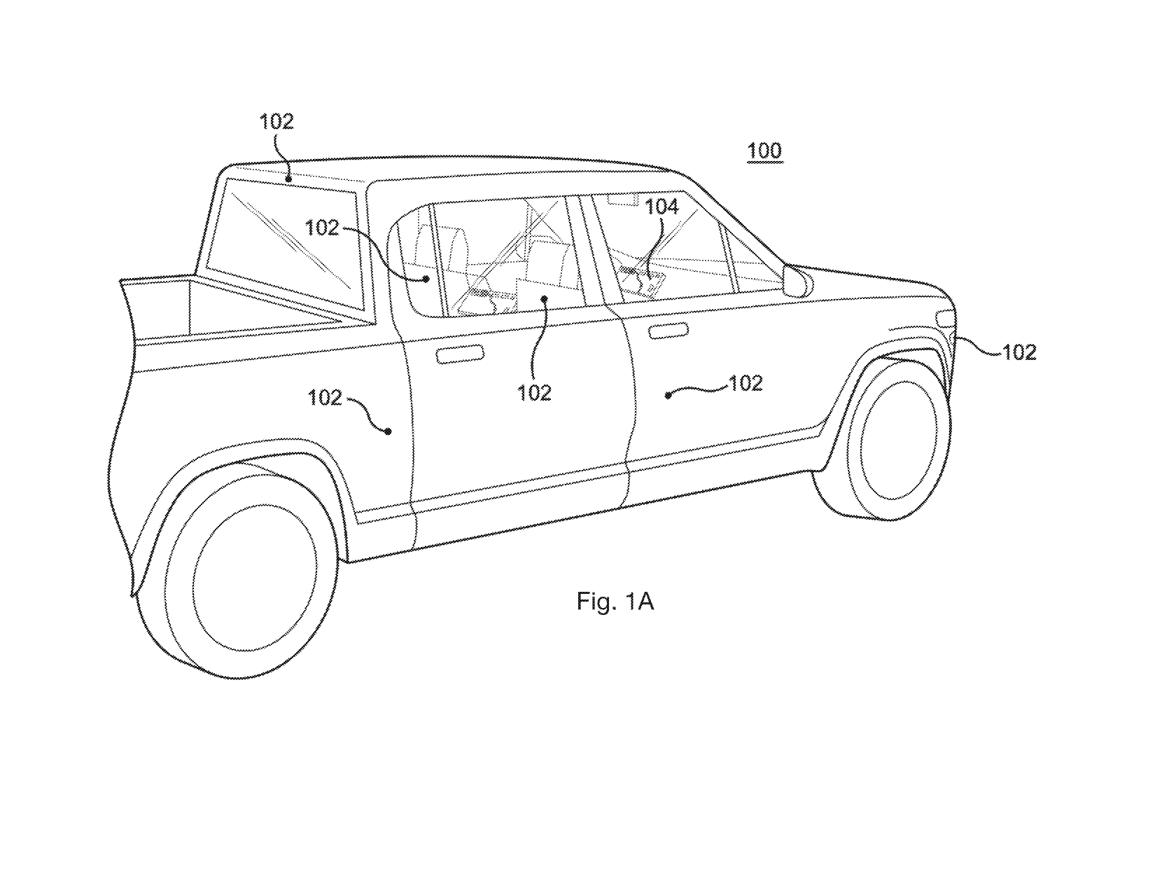

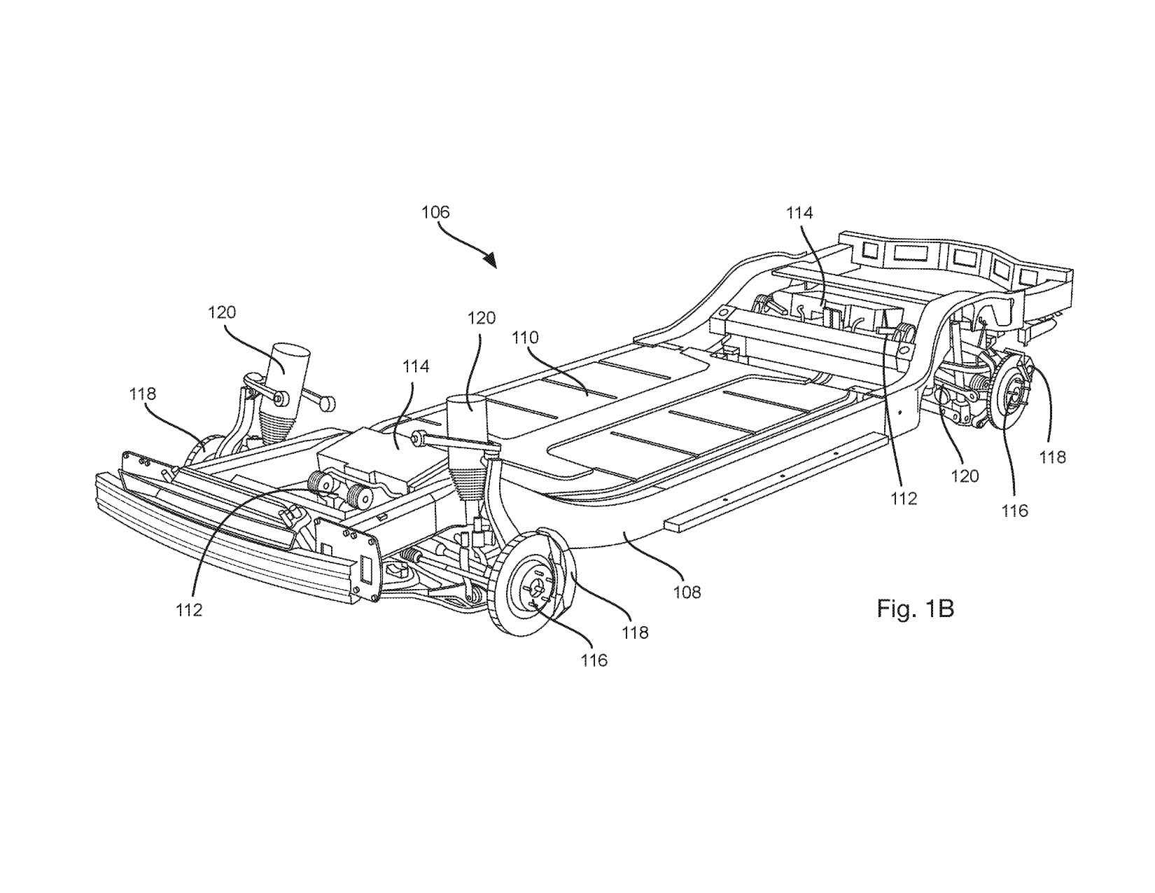

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

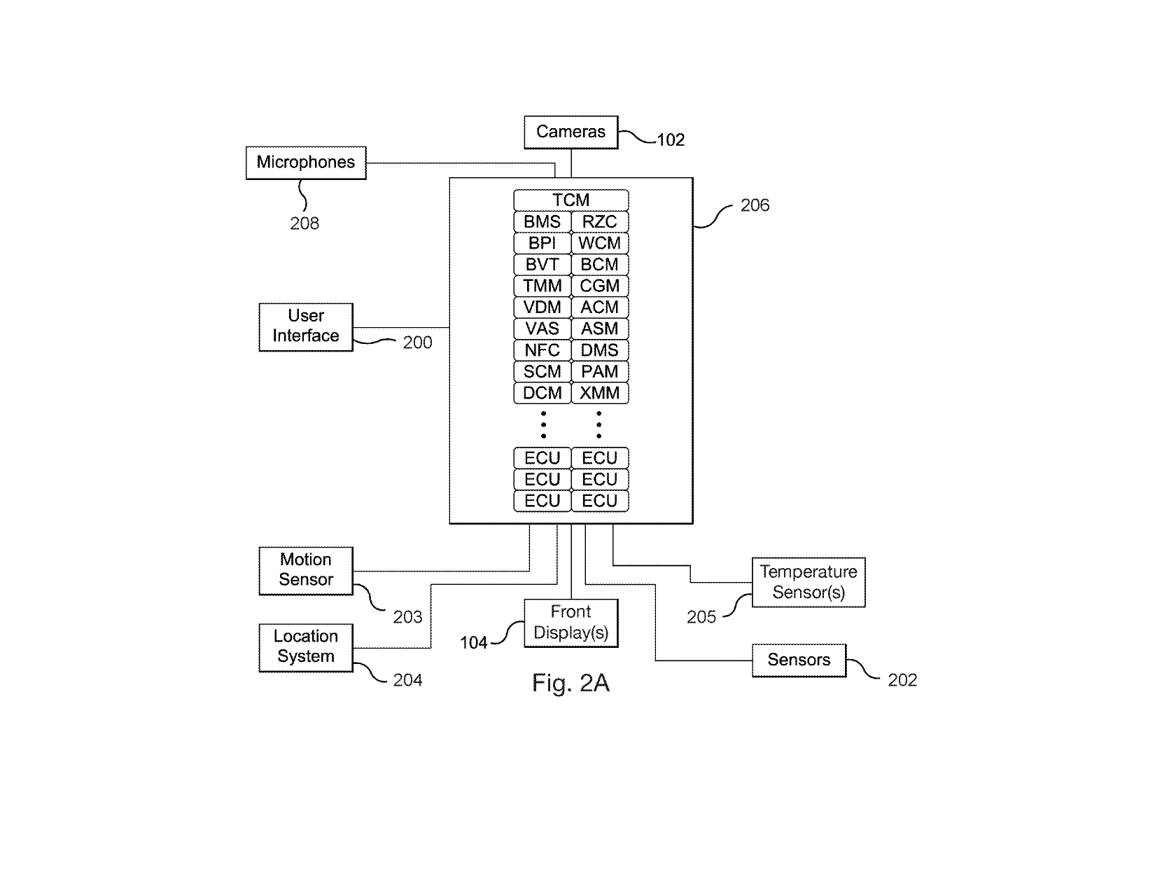

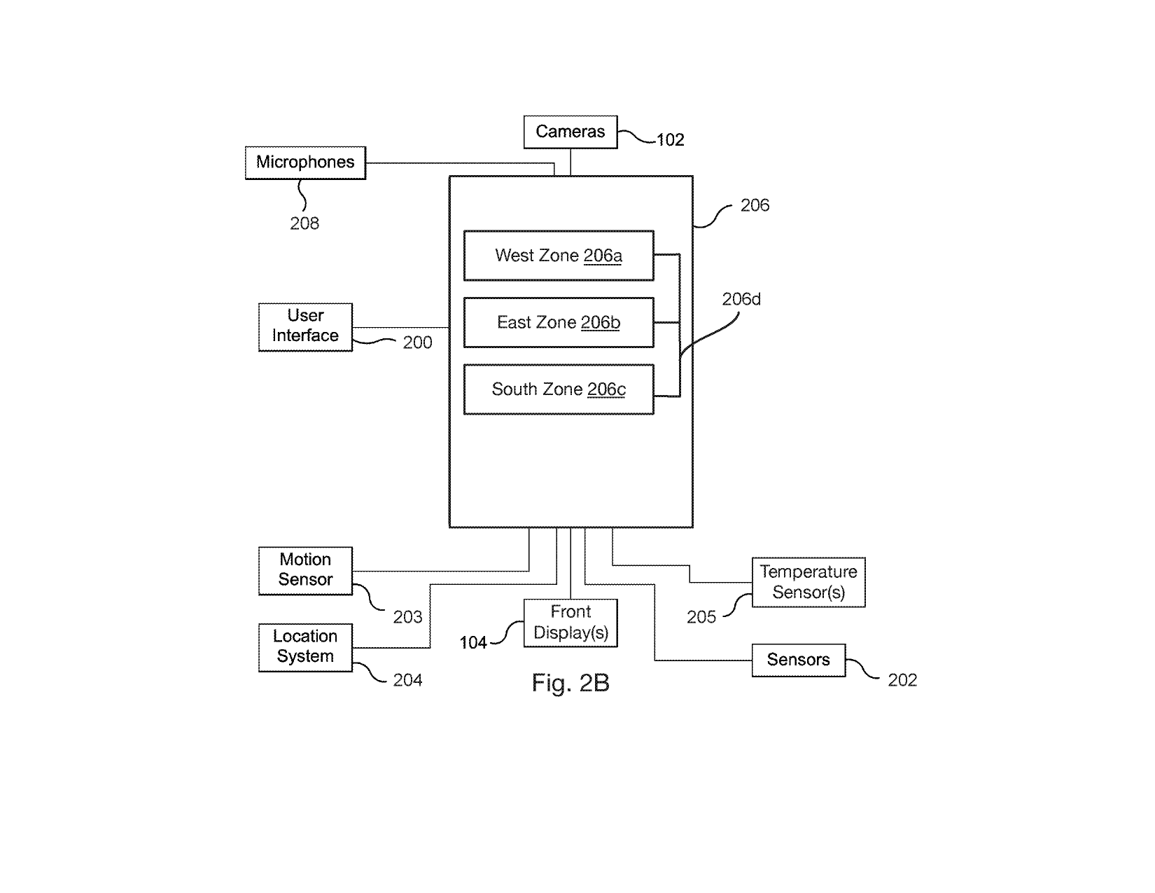

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

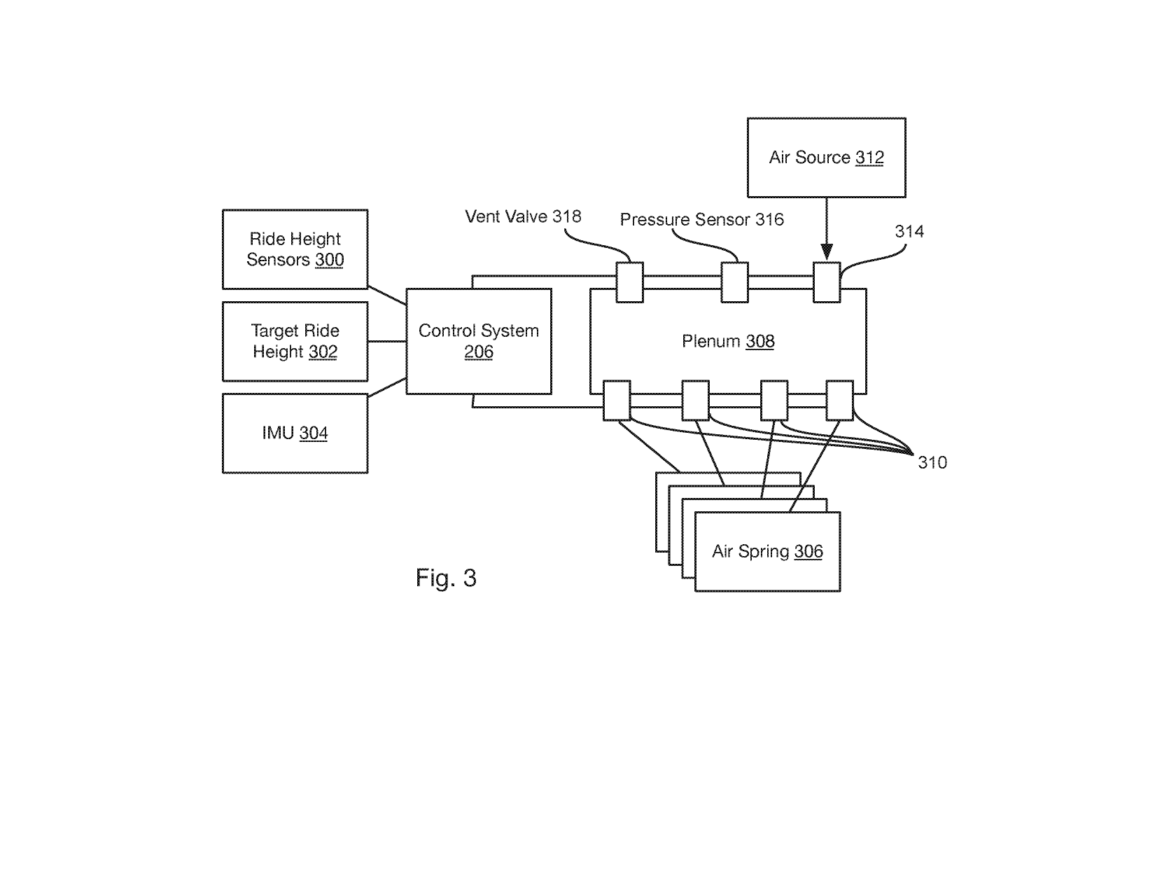

A control system 206 executes instructions to perform at least some of the actions or functions of the vehicle 100, including the functions described in relation to FIGS. 3 to 5. For example, as shown in FIG. 2, the control system 206 may include one or more electronic control units (ECUs) configured to perform at least some of the actions or functions of the vehicle 100, including the functions described in relation to FIGS. 3 to 5. In certain embodiments, each of the ECUs is dedicated to a specific set of functions. Each ECU may be a computer system, and each ECU may include functionality described below in relation to FIGS. 3 to 5.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIGS. 3 to 5.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

Referring to FIG. 3, the control system 206 may control the ride height of the vehicle 100 by controlling operation of the suspensions 120. The ride height may be controlled based on the outputs of ride height sensors 300 that sense the current height of each suspension 120. The control system 206 may receive a target ride height 302 from a user based on an explicit instruction to achieve the target ride height 302, in response to selection of a drive mode having the target ride height 302 associated therewith, on startup of the vehicle to facilitate entry (kneeling), or in response to some other event.

As discussed in greater detail below, adjustment of the ride height when the vehicle 100 is on a non-level and non-flat surface, e.g., a sloped or irregular surface, may be handled differently than when the vehicle 100 is on a level and flat surface. The orientation of the vehicle 100 and the irregularity of a surface supporting the vehicle 100 may be detected based on the outputs of the ride height sensors 300. The orientation may also be detected based on an inertial measurement unit (IMU) 304 configured to sense acceleration. For example, the IMU 304 may include a three- or six-axis accelerometer configured to detect acceleration of the vehicle 100, including the direction of gravity.

The suspensions 120 may be air suspensions including air springs 306. The mass of air within the air springs 306 may be adjusted to change the ride height of the vehicle 100. The control of air flow to the air springs 306 may be facilitated using a plenum 308. The plenum 308 may define a volume that is connected to the air springs 306 by way of valves 310, each valve 310 controlling the flow of air between one air spring 306 and the plenum 308.

The plenum 308 may further be connected to an air source 312. The air source 312 may include a compressor. The air source 312 may further include a reservoir for storing compressed air. The air source 312 may include any air source and reservoir known in the art and may include feedback control that activates the compressor in response to pressure within the reservoir falling below a set pressure. A valve 314 may control the flow of air between the air source 312 and the plenum 308.

A pressure sensor 316 may be configured to detect pressure within the plenum and be used to perform feedback control. A vent valve 318 may be opened to connect the plenum 308 to ambient air in order to release air into the environment.

The pressure within an air spring 306 may be measured by opening the valve 310 connected to that, and only that, air spring 306 while closing the valve 314 connected to the air source 312 and closing the vent valve 318. In this configuration, the output of the pressure sensor 316 may be used as an estimate of the pressure within that air spring 306.

The control system 206 may be coupled to the ride height sensors, IMU 304, and pressure sensor 316 and receives outputs therefrom. The control system 206 is coupled to the valves 310, 314, 318 and controls opening and closing of the valves 310, 314, 318, such as according to the methods disclosed herein.

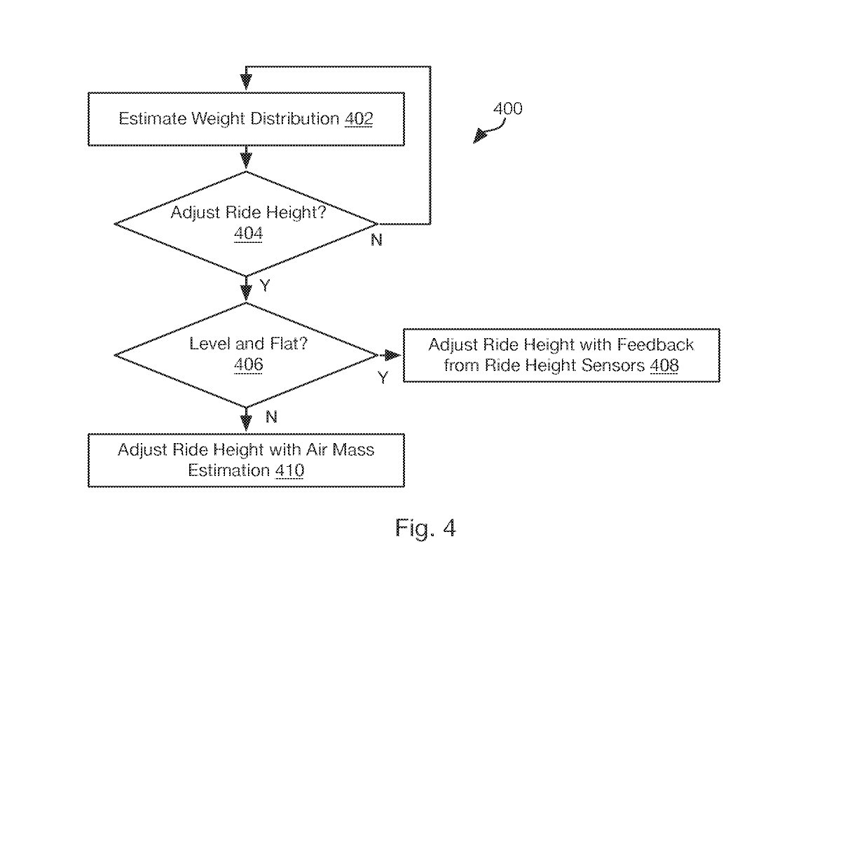

FIG. 4 illustrates a method 400 that may be implemented by the control system 206 to control ride height. The method 400 may presume that the vehicle 100 is stopped or traveling at a slow speed (e.g., less than 20 miles per hour). The method 400 may include estimating, at step 402, the current weight distribution of the vehicle. Step 402 may include estimating the amount of weight on each suspension 120. The weight distribution may be measured by measuring the pressure in each air spring 306 and ride height of each air spring while the vehicle 100 is approximately (e.g., within 5 degrees of) level and deriving the weight distribution from these measurements. The weight on each suspension 120 may be determined according to any approach known in the art. Step 404 may be performed periodically. The weight distribution does not change rapidly, accordingly, step 404 may be suspended once a good weight distribution measurement has been obtained during a driving cycle, e.g., while the vehicle is stopped on an approximately (e.g., within 2 degrees of) level surface.

The method 400 may include evaluating, at step 404, whether an adjustment of ride height has been triggered. For example, in response to a change in drive mode, an explicit instruction from a user, a change in speed of the vehicle (e.g., driving from a parked position at which the vehicle 100 was lowered to facilitate entry), or other trigger.

If an adjustment of ride height has been triggered, the method 400 may include evaluating, at step 406, whether the vehicle 100 meets a flatness and levelness requirement. For example, step 406 may include evaluating whether the vehicle 100 is on a level (e.g., within 5, 3, or 2 degrees of level) surface and on a flat surface (e.g., height differences among the suspensions 120 caused by support surface variation being within 5, 3, or 2 centimeters of equal to one another).

If the vehicle 100 is found to be on a flat and level surface as defined above, then the method 400 may include adjusting, at step 408, ride height with feedback from the ride height sensors 300. In particular, the air springs 306 may be coupled to the air source 312 using valves 310, 314 in order to raise the ride heights of the suspensions 120 until outputs of the ride height sensors 300 indicate that the target ride height 302 is achieved if the current ride height is less than the target ride height 302. The air springs 306 may be coupled to the environment using valves 310, 318 in order to lower the ride heights of the suspensions 120 until the outputs of the ride height sensors 300 indicate that the target ride height 302 has been achieved if the current ride height is higher than the target ride height 302. The valves 310 may be opened one at a time during raising or lowering, such as to account for an unequal weight distribution. Feedback control may be used to stop adjustment when the ride heights are within a threshold (e.g., 20, 10, or 5 millimeters) of the target ride height. Feedback control based on ride height may be performed according to any approach known in the art.

If the vehicle is not found to be on a level and flat surface as defined above with respect to step 406, the ride height may be adjusted at step 410 with feedback according to estimated air mass within the air springs 306.

When a vehicle is on a non-flat and non-level surface, a first loading on the suspensions 120 will be different from a second loading when on a flat and level surface. Accordingly, adjustment based on ride height when the vehicle is on a non-flat and non-level surface will result in an air mass within each air spring 306 corresponding to the first loading. When the vehicle 100 transitions to the second loading, the ride heights of the suspensions 120 will change in response to the change in loading, which may result in unequal ride heights of the suspensions 120, which may persist for a time until feedback control based on ride height causes equalization. In prior approaches, the vehicle 100 is constrained to be on a flat and level surface before adjustment of ride height can be adjusted in order to avoid this problem. Using feedback control based on air mass, adjustment of ride height can be enabled on a larger range of surface angles and degrees of surface irregularity while reducing inequality in ride heights of the suspensions 120 when returning to flat and level surfaces.

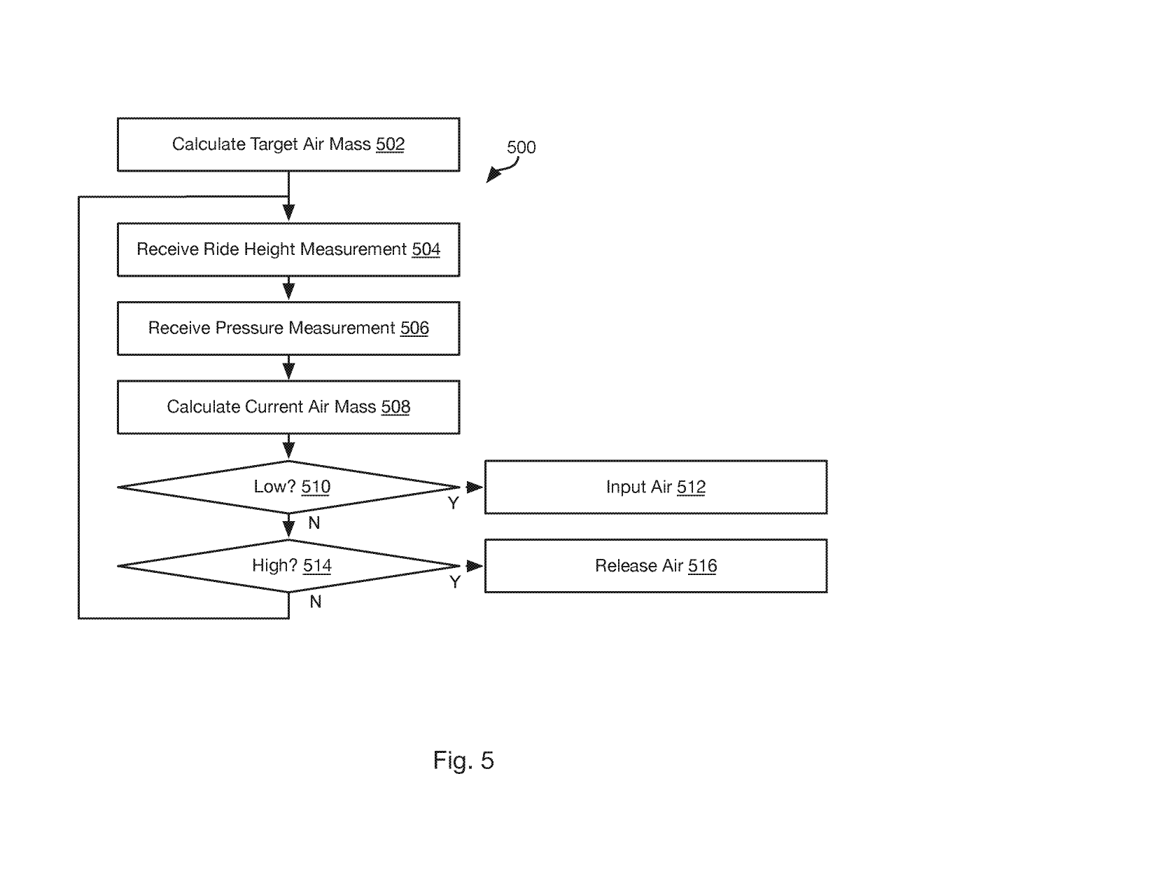

FIG. 5 illustrates a method 500 that may be implemented by the control system 206 in order to perform feedback control using estimated air mass within each air spring 306. The method 500 may be performed for each air spring 306 of the vehicle 100, hereinafter referred to simply as “the air spring 306.”

The method 500 may include calculating, at step 502, an air mass for the air spring 306. In particular, for the load on the air spring 306 as determined by the weight distribution, the target ride height, an air mass that gives the target ride height when the vehicle is on a flat and level surface may be calculated. For example, a manufacture may provide data relating ride height (e.g., air spring 306 length) to volume of the air spring 306. The pressure required to support the load on the air spring 306 may be calculated as well based on a known relationship between loading and pressure within the air spring 306, e.g., load = pressure * area, where area is the effective area acted on by pressure in the air spring 306 in order to support the load.

It may be assumed that the pVⁿ = air mass, where p is pressure required for the air spring 306 to support the load on a flat and level surface, V is volume of the air spring 306 at the target ride height, and n is the polytropic constant of air. The relationship between air mass, pressure, and volume assumes a constant temperature, which is a valid approximation for the vehicle 100.

The method 500 may include receiving, at step 504, a ride height measurement from the ride height sensor 300 for the suspension 120 including the air spring 306. Step 504 may include receiving multiple readings from the ride height sensor 300 over time and averaging the multiple readings and/or low-pass filtering the multiple readings to obtain the ride height measurements. Various other approaches may also be used to remove noise from ride height measurements resulting from acceleration of the vehicle 100.

The method 500 may include, receiving, at step 506, a pressure measurement measuring pressure within the air spring 306. A pressure measurement may be obtained using the pressure sensor 316 of the plenum 308 as described above. Alternatively, each air spring 306 may have a dedicated pressure sensor measuring the pressure thereof. Step 504 may include receiving pressure readings from the ride pressure sensor 316 over time and averaging the multiple readings to obtain the ride pressure measurements. The pressure readings may also be processed to compensate for acceleration of the vehicle. For example, pressure readings over time may be low-pass filtered with the output of the low-pass filter being used as the pressure measurement according to the method 500.

The method may include calculating, at step 508 a current air mass, such as according to pVⁿ = air mass, where p is the pressure measurement from step 506, V is the volume of the air spring corresponding to the ride height measurement from step 504, and n is the polytropic constant of air.

If the current air mass is found, at step 510, to be lower than the target air mass, then air is input to the air spring 306 at step 512, such as by simultaneously opening the valve 310 of the air spring 306 and the valve 314 and releasing air from the air source 312 into the air spring 306.

If the current air mass is found, at step 514, to be higher than the target air mass then air is released from the air spring 306 at step 516, such as by simultaneously opening the valve 310 of the air spring 306 and the vent valve 318.

Opening of valves 314, 318 may be performed in a pulsed manner with checking of the output of the pressure sensor 316 between pulses. For example, while air is flowing into an air spring 306, the pressure measurement for an air spring 306 may be estimated as the output of the pressure sensor 316 minus a calibrated pressure drop. When the flow rate into the air spring 306 is very high, pressure measurements may be obtained by pulsing opening of the valve 314 while the valve 310 to the air spring 306 is open. Pressure readings using the pressure sensor 316 may then be taken between pulses when the valve 314 is closed. In a like manner, when air is being released from the air spring 306, opening of the valve 318 may be pulsed while the valve 310 to the air spring 306 is open. Pressure readings using the pressure sensor 316 may then be taken between pulses when the valve 318 is closed. Pulsing opening of the valves 314, 318 slows the rate of ride height adjustment to avoid overshooting and undershooting.

The method 500 may repeat from step 504 to reach or maintain the target air mass. The method 500 may end when the vehicle is on a flat and level surface as defined above for step 406, at which point feedback based on ride height measurements may be performed.

The feedback control loop of steps 504-516 may be performed iteratively for each suspension 120. For example, one suspension 120 may be adjusted according to the method 500 at a time until all suspensions 120 have been adjusted according to the method 500. Adjusting one suspension 120 at a time may help avoid a suspension 120 that is loaded less than another suspension 120 from overshooting a target air mass.

The air mass in an air spring 306 calculated according to the method 500 may be used for other purposes. For example, using ride height measurements, an updated value of the volume V of the air spring 306 may be calculated. Assuming a constant air mass and the relation pVⁿ = constant, the pressure p may be estimated from the ride height measurement and used for various purposes, such as a traction control algorithm, to estimate instantaneous loading when rock crawling, or other uses. The pressure in an air spring 306 calculated from ride height measurement may be used to prime the plenum 308 before opening the valve 310, e.g., to ensure that the plenum 308 is above the pressure in the air spring 306 when adding air to the air spring 306 to avoid losing air.

Air mass in an air spring 306 may be used to estimate leakage of the air spring 306. For example, on shut down, air mass estimated according to the method 500, such as one or more samples of air mass for each air spring 306, may be stored in a non-volatile memory. In some embodiments, an air mass estimate is stored only if calculated from valid pressure and ride height samples, for example, when the air mass estimate is calculated from pressure and ride height samples acquired during that operating cycle and no ride height adjustments have taken place since the pressure and ride height samples were acquired. At startup, samples of air mass may be read from the non-volatile memory and used to initialize air spring pressure models for each air spring 306 and calculate air loss magnitude for each air spring 306. If the suspension has sagged (e.g., ride height reduced) substantially since the last operating cycle (e.g., >10mm on any corner) then the control system 206 may, in response, immediately sample the air mass in each air spring 306 to enable accurate leak rate calculation and may proceed to increase the air mass in each spring 306. If the suspension has not sagged since the last operating cycle, the control system 206 may wait to trigger a sampling until driveaway (e.g., speed >20km/h) to mask the noise of the valves opening and closing.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

What is claimed is:

1. A vehicle controller configured to:
receive an instruction to adjust a ride height of a vehicle; and
if a surface supporting the vehicle does not meet a requirement for flatness and levelness, adjust an amount of air in an air spring of each suspension of a plurality of suspensions of the vehicle to achieve a target air mass for each suspension.

2. The vehicle controller of claim 1, further configured to:
if the surface supporting the vehicle meets the requirement for flatness and levelness, adjust the amount of air in the air spring of each suspension of the plurality of suspensions of the vehicle to achieve a target output from a ride height sensor of each suspension.

3. The vehicle controller of claim 1, further configured to adjust the ride height to achieve the target air mass in the air spring of each suspension of the plurality of suspensions by, for each suspension of the plurality of suspensions:
receiving a ride height measurement from a ride height sensor of each suspension;
receiving a pressure measurement of pressure in the air spring of each suspension;
calculating an estimated air mass according to the ride height measurement and the pressure measurement; and
adjusting the amount of air in the air spring according to the estimated air mass and the target air mass for each suspension.

4. The vehicle controller of claim 3, further configured to, for each suspension of the plurality of suspensions:
calculate a volume of the air spring of each suspension according to the ride height measurement; and
calculate the estimated air mass according to pVⁿ, where p is the pressure measurement, V is the volume, and n is polytropic constant of air.

5. The vehicle controller of claim 1, further configured to:
estimate a loading of each suspension of the plurality of suspensions;
receive a ride height measurement from a ride height sensor of each suspension;
receive a pressure measurement of pressure in the air spring of each suspension; and
calculate the target air mass for each suspension according to the loading, the ride height measurement, and the pressure measurement.

6. The vehicle controller of claim 1, wherein the requirement for flatness and levelness includes an angle of less than 5 degrees.

7. The vehicle controller of claim 1, wherein the requirement for flatness and levelness includes height differences among the plurality of suspensions of less than 5 centimeters.

8. A vehicle comprising:
a plurality of suspensions, each including an air spring; and
a vehicle controller coupled to the air spring of each suspension of the plurality of suspensions, the vehicle controller configured to:
receive an instruction to adjust a ride height of the vehicle; and
if a surface supporting the vehicle does not meet a requirement for flatness and levelness, adjust an amount of air in the air spring of each suspension of the plurality of suspensions of the vehicle to achieve a target air mass for each suspension.

9. The vehicle of claim 8, wherein the vehicle controller is further configured to:
if the surface supporting the vehicle meets the requirement for flatness and levelness, adjust the amount of air in the air spring of each suspension of the plurality of suspensions of the vehicle to achieve a target output from a ride height sensor of each suspension.

10. The vehicle of claim 8, further comprising one or more pressure sensors configured to sense pressure in the air spring of each suspension of the plurality of suspensions;
wherein:
each suspension of the plurality of suspensions includes a ride height sensor; and
the vehicle controller is further configured to adjust the ride height to achieve the target air mass in the air spring of each suspension of the plurality of suspensions by, for each suspension of the plurality of suspensions:
receiving a ride height measurement from the ride height sensor of each suspension;
receiving a pressure measurement of the pressure in the air spring of each suspension from the one or more pressure sensors;
calculating an estimated air mass according to the ride height measurement and the pressure measurement; and
adjusting the amount of air in the air spring according to a difference between the estimated air mass and the target air mass for each suspension.

11. The vehicle of claim 10, further comprising:
an air source;
a plenum;
a first valve controlling air flow from the air source into the plenum;
a second valve controlling air flow from the plenum to an environment of the vehicle;
a plurality of third valves, each controlling air flow to and from the air spring of one suspension of the plurality of suspensions; and
wherein the vehicle controller is further configured to add air to the air spring of each suspension of the plurality of suspensions by opening the first valve and a third valve of the plurality of third valves controlling the air flow to and from the air spring of each suspension of the plurality of suspensions.

12. The vehicle of claim 11, wherein the vehicle controller is further configured to remove air from the air spring of each suspension of the plurality of suspensions by the third valve of the plurality of third valves controlling the air flow to and from the air spring of each suspension of the plurality of suspensions.

13. The vehicle of claim 11, wherein the one or more pressure sensors include a pressure sensor configured to sense pressure within the plenum, the vehicle controller being further configured to measure the pressure in the air spring of each suspension of the plurality of suspensions by:
opening the second valve and the third valve of the plurality of third valves controlling the air flow to and from the air spring of each suspension of the plurality of suspensions; and
receiving an output of the pressure sensor.

14. The vehicle of claim 10, wherein the vehicle controller is further configured to, for each suspension of the plurality of suspensions:
calculate a volume of the air spring of each suspension according to the ride height measurement; and
calculate the estimated air mass according to pVn, where p is the pressure measurement, V is the volume, and n is polytropic constant of air.

15. The vehicle of claim 8, further comprising one or more pressure sensors configured to sense pressure in the air spring of each suspension of the plurality of suspensions;
wherein:
each suspension of the plurality of suspensions includes a ride height sensor; and
the vehicle controller is further configured to:
estimate a loading of each suspension of the plurality of suspensions;
receive a ride height measurement from the ride height sensor of each suspension;
receive a pressure measurement of the pressure in the air spring of each suspension from the one or more pressure sensors; and
calculate the target air mass for each suspension according to the loading, the ride height measurement, and the pressure measurement.

16. The vehicle of claim 8, wherein the requirement for flatness and levelness includes an angle less than 5 degrees.

17. The vehicle of claim 16, further comprising an inertial measurement unit (IMU), the vehicle configured to sense the angle via the IMU.

18. The vehicle of claim 8, wherein the requirement for flatness and levelness includes height differences among the plurality of suspensions of less than 5 centimeters.

19. A non-transitory computer-readable medium storing executable code that, when executed by a vehicle controller, causes the vehicle controller to:
receive an instruction to adjust a ride height of a vehicle; and
if a surface supporting the vehicle does not meet a requirement for flatness and levelness, adjust an amount of air in an air spring of each suspension of a plurality of suspensions of the vehicle to achieve a target air mass for each suspension.

20. The non-transitory computer-readable medium of claim 19, wherein the executable code, when executed by the vehicle controller, further causes the vehicle controller to:
if the surface supporting the vehicle meets the requirement for flatness and levelness, adjust the amount of air in the air spring of each suspension of the plurality of suspensions of the vehicle to achieve a target output from a ride height sensor of each suspension.
